(19) United States
(12) Patent Application Publication
(10) Pub. No.: US 2025/0292483 A1
(43) Pub. Date: Sep. 18, 2025

(54) REAL-TIME CONVERSION OF 2D VIDEO INTO 3D HOLOGRAPHIC VIDEO CONTENT USING A HEADSET DEVICE

(71) Applicant: Yosemite Vision Inc., Oakton, VA (US)

(72) Inventor: Kenneth Lee, Fairfax, VA (US)

(21) Appl. No.: 19/078,655

(22) Filed: Mar. 13, 2025

Related U.S. Application Data
(60) Provisional application No. 63/565,945, filed on Mar. 15, 2024.

(51) Int. Cl. G06T 15/04; G02B 27/01; G06F 3/01; G06T 7/20; G06T 7/579; G06T 7/70; G06V 10/25; G06V 40/16

(52) U.S. Cl. CPC G06T 15/04; G02B 27/017; G06F 3/013; G06T 7/20; G06T 7/579; G06T 7/70; G06V 10/25; G06V 40/172

(57) ABSTRACT

A method and system for real-time conversion of two-dimensional (2D) video into three-dimensional (3D) holographic video content includes a headset device configured to capture video that includes a screen displaying 2D video content. The headset identifies a region of interest in the captured video that corresponds to a subject in the 2D video content, converts the captured video into a 3D depth map including an initial 3D model of the subject, overlays an initial high-definition texture on the initial 3D model of the subject, the initial texture generated from the captured video, and reproject the textured initial 3D model into displays of the headset device to align with the subject in the 2D video content.

### RELATED APPLICATIONS

This application claims priority to U.S. Provisional Patent Application No. 63/565,945, filed on Mar. 15, 2024, the entirety of which is incorporated herein by reference.

### TECHNICAL FIELD

The subject matter of this application relates generally to methods and apparatuses, including computer program products, for real-time conversion of two-dimensional (2D) video into three-dimensional (3D) holographic video content using a headset device.

### BACKGROUND

Wearable headset devices—such as augmented reality (AR) devices, mixed reality (MR) devices, virtual reality (VR) devices, and other types of extended reality (XR) devices and spatial computers—have become relatively commonplace over the last several years. A notable example is the Apple® Vision Pro™ headset, which includes a lens/display component that enables a user to view digital content rendered by processing hardware in the headset while also continuing to see real world objects and surroundings. While wearing this type of device, a user can watch video content on an external display device, such as the screen of a handheld mobile device (e.g., tablet, smartphone), a television, or a computer monitor. However, in these situations, the user is simply watching regular 2D video as they normally would without the headset—as can be appreciated, the headset is unnecessary, and it may be distracting or cumbersome for the user.

Current applications attempt to utilize the graphical processing unit (GPU) hardware found in many spatial computing headsets to convert a 2D video stream displayed on an external screen into a 3D holographic video stream using AI-based technology (such as generative AI processing). In some cases, the 3D holographic video stream is then reprojected back into the real world, to make it appear that the 3D video is on top of the screen itself. This creates a 3D augmented reality viewing experience where the user can still interact with their surroundings (e.g., see and interact with other people and scenes) while also enjoying the personal 3D viewing experience via the headset display.

As can be appreciated, the above-described conversion process is resource intensive; it typically requires a large amount of computing power and processing bandwidth. Unfortunately, current commercial spatial computing headsets have limited GPU processing power and battery capacity-which prevents these headsets from being able to handle the processing needs sufficiently to perform real-time conversion of 2D video into 3D holographic video.

### SUMMARY

Therefore, what is needed are improved methods and systems for converting 2D video into 3D holographic video content in real time using wearable headset devices. The techniques described herein advantageously leverage the existing hardware in such headsets to generate and display live 3D holographic video based upon 2D video content in an efficient manner while also delivering a high-quality visual experience.

The invention, in one aspect, features a system for real-time conversion of two-dimensional (2D) video into three-dimensional (3D) holographic video content. The system comprises a wearable headset device including: one or more cameras configured to capture a front-facing field of view, and one or more displays configured to present digital content to a user of the headset device. The headset device captures, using the one or more cameras, video that includes a client computing device in proximity to the user, the client computing device comprising a screen displaying 2D video content. For a first one or more frames of the captured video, the headset device: identifies a region of interest in the first one or more frames that corresponds to a subject in the 2D video content displayed on the client computing device; converts the first one or more frames into a 3D depth map including an initial 3D model of the subject; overlays an initial high-definition texture on the initial 3D model of the subject, the initial texture generated from the first frame; and reprojects the textured initial 3D model in the displays of the headset device to align with the subject in the 2D video content. For each subsequent frame of the captured video, the headset device: identifies a region of interest in the subsequent frame that corresponds to the subject; converts the subsequent frame into a 3D depth map including a current 3D model of the subject; deforms the initial 3D model of the subject to match the current 3D model of the subject; overlays a current high-definition texture on the deformed 3D model of the subject, the current texture generated from the subsequent frame; and reprojects the textured current 3D model in the displays of the headset device to align with the subject in the 2D video content.

The invention, in another aspect, features a computerized method of real-time conversion of two-dimensional (2D) video into three-dimensional (3D) holographic video content. A wearable headset device includes one or more cameras configured to capture a front-facing field of view, and one or more displays configured to present digital content to a user of the headset device. The headset device captures, using the one or more cameras, video that includes a client computing device in proximity to the user, the client computing device comprising a screen displaying 2D video content. For a first one or more frames of the captured video, the headset device: identifies a region of interest in the first one or more frames that corresponds to a subject in the 2D video content displayed on the client computing device; converts the first one or more frames into a first 3D depth map including creating an initial 3D model of the subject using the first depth map; overlays an initial high-definition texture on the initial 3D model of the subject, the initial texture generated from the first frame; and reprojects the textured initial 3D model in the displays of the headset device to align with the subject in the 2D video content. For each subsequent frame of the captured video, the headset device: identifies a region of interest in the subsequent frame that corresponds to the subject; converts the subsequent frame into a subsequent 3D depth map including creating a current 3D model of the subject using the subsequent depth map; deforms the initial 3D model of the subject to match the current 3D model of the subject; overlays a current high-definition texture on the deformed 3D model of the subject, the current texture generated from the subsequent frame; and reprojects the textured current 3D model in the displays of the headset device to align with the subject in the 2D video content.

Any of the above aspects can include one or more of the following features. In some embodiments, the headset device registers a pose of the screen of the client computing device and tracks a location of the screen through each frame of the captured video. In some embodiments, the headset device uses a simultaneous localization and mapping (SLAM) algorithm to perform the pose registration and screen tracking.

In some embodiments, identifying a region of interest in the first one or more frames comprises capturing input from the user; and identifying the region of interest in the first one or more frames based upon the user input. In some embodiments, capturing input from the user comprises determining, using one or more sensors of the headset device, a gaze of the user's eyes toward the screen of the client computing device. In some embodiments, capturing input from the user comprises determining a location of the user's hand in the first one or more frames in relation to the screen of the client computing device.

In some embodiments, the headset device converts the frames into the 3D depth maps using a monocular depth map generation technique. In some embodiments, for each subsequent frame of the captured video, the headset device compares the current 3D model to the initial 3D model to enable tracking of the movements of both the underlying mesh structure of the 3D model and the texture. In some embodiments, the headset device compares the current 3D model to the initial 3D model using landmarks or an optical flow algorithm.

In some embodiments, for the first one or more frames of the captured video, the headset device retrieves a reference 3D model based upon one or more characteristics of the subject in the 2D video content; deforms the reference 3D model to match the initial 3D model of the subject; and overlays the initial high-definition texture on the deformed initial 3D model of the subject to generate the textured initial 3D model. In some embodiments, the headset device deforms the initial 3D model of the subject to match the current 3D model of the subject using a deformable simultaneous localization and mapping (SLAM) algorithm. In some embodiments, the deformable SLAM algorithm uses gaussian splat (gsplat)-based blendshapes to convert the frames into 3D models and track deformation of the 3D models using features.

In some embodiments, the headset device uses a sparse deformation graph to compute the deformations and generates a dense vector warp field that represents the warping of the current frame to the previous frame.

In some embodiments, for each frame of the captured video, the headset device segments the frame based upon the identified region of interest. In some embodiments, the headset device uses a facial recognition algorithm or a body recognition algorithm to perform the segmentation.

In some embodiments, the subject in the 2D video content comprises a person and the region of interest comprises one or more of: the person's body, the person's head and shoulders, or the person's face. In some embodiments, reprojecting the textured 3D model in the displays of the headset device to align with the subject in the 2D video content provides an appearance to the user that the textured 3D model is coming out of the screen of the client computing device. In some embodiments, the user views the reprojected textured 3D model in context with the 2D video content. In some embodiments, the user views real-world surroundings concurrently with the textured 3D model and the 2D video content. In some embodiments, the headset device continually refines the textured 3D model for display to the user as each subsequent frame is processed. In some embodiments, the headset device processes one or more of the initial high-definition texture and the current high-definition texture using a generative AI diffusion model algorithm to increase an image quality of the textured 3D model.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for real-time conversion of 2D video into 3D holographic video content using a headset device.

FIG. 2 is a flow diagram of a computerized method of generating a textured 3D model from 2D video.

FIG. 3 is a diagram of an exemplary 3D holographic video stream generated by the system.

FIG. 4 is a flow diagram of a computerized method of real-time conversion of 2D video into 3D holographic video content using a headset device

### DETAILED DESCRIPTION

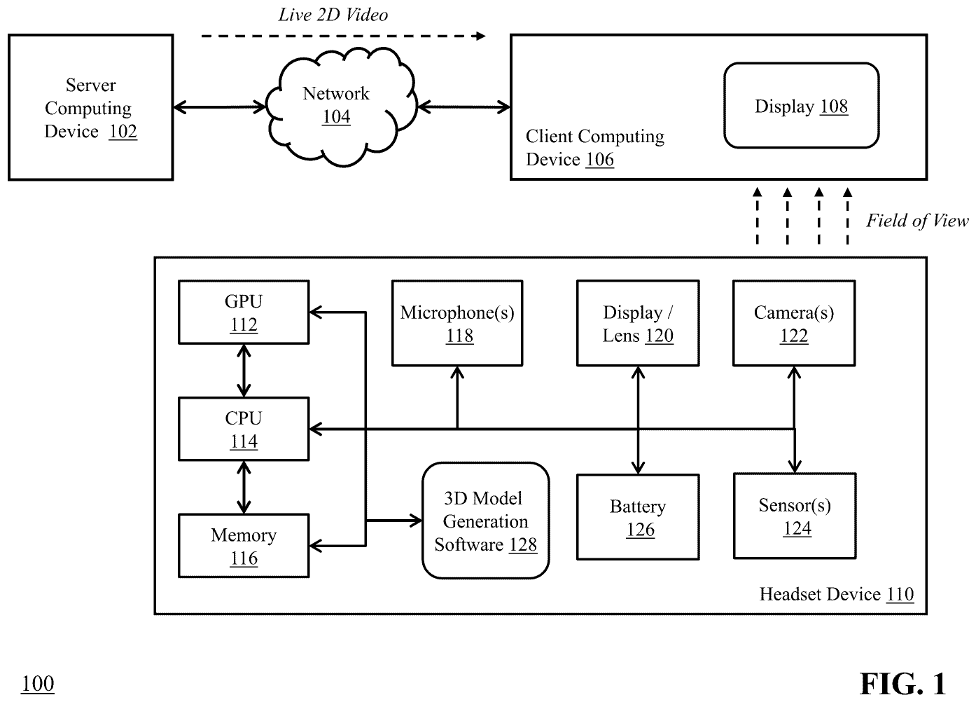

FIG. 1 is a block diagram of system 100 for real-time conversion of 2D video into 3D holographic video content using a headset device. System 100 includes server computing device 102 coupled to a communications network 104 that connects server computing device 102 to client computing device 106. Client computing device 106 includes display device 108 (e.g., a screen for viewing 2D video).

Server computing device 102 is a combination of hardware and software modules that includes specialized hardware and/or software modules that execute on one or more processors and interact with memory modules of server computing device 102 to transmit video content (e.g., live content streaming) to client computing device 106 via network 104. In some embodiments, server computing device 102 is part of a content streaming platform that delivers video content of live events for display on client computing device 106. It should be appreciated that server computing device 102 can be implemented as any number of computing devices, arranged in a variety of architectures, resources, and configurations (e.g., cluster computing, virtual computing, cloud computing) without departing from the scope of the technology described herein.

Network 104 enables the other components of system 100 to communicate with each other in order to perform functions relating to the process of real-time conversion of 2D video into 3D holographic video content using a headset device as described herein. Network 104 may be a local network, such as a LAN, or a wide area network, such as the Internet and/or a cellular network. In some embodiments, network 104 is comprised of several discrete networks and/or sub-networks (e.g., cellular to Internet) that enable the components of the system of FIG. 1 to communicate with each other.

Client computing device 106 uses software and circuitry (e.g., one or more processors and memory modules) to execute applications and communicate with server computing device 106 via communications network 104. In some embodiments, client computing device 106 receives video content (e.g., streaming video) from server computing device 102 and displays the video content on display screen 108 of device 106. Exemplary client computing devices 106 include, but are not limited to, tablets (e.g., Apple® iPad®), smartphones (e.g., Apple® iPhone®), desktop computers, laptop computers, and smart televisions. It should be appreciated that other types of computing devices that are capable of connecting to the components of system 100 of FIG. 1 can be used without departing from the scope of the technology described herein. Although FIG. 1 depicts a single client computing device 106, it should be appreciated that system 100 can include any number of client computing devices.

System 100 also comprises headset device 110, which includes a combination of specialized hardware and/or software modules that execute programmatic instructions to receive data, process data, display data, and transmit data, and to communicate with other devices of system 100 in order to perform functions for real-time conversion of 2D video into 3D holographic video content as described herein. Headset device 110 includes graphics processing unit (GPU) hardware 112, central processing unit (CPU) hardware 114, memory 116 (e.g., solid state RAM), one or more microphones 118, a display/lens apparatus 120 (e.g., one or more micro-OLED displays that can adjustably display digital content while also enabling a wearer to see real-world surroundings), one or more cameras 122), one or more sensors 124 (e.g., accelerometers, gyroscopes, iris trackers), battery 126, and 3D model generation software 128. Exemplary headset devices 110 include, but are not limited to, the Apple® Vision Pro™ headset. In some embodiments, although not shown in FIG. 1, headset device 110 also includes one or more speakers to produce audio content for the wearer and networking hardware (e.g., Bluetooth™, WiFi™) to enable headset device 110 to wirelessly connect to client computing device 106 and/or network 104. In some embodiments, 3D model generation module 128 is one or more specialized sets of computer software instructions programmed onto a processor (e.g., GPU 112, CPU 114) in headset device 110 and can include designated memory locations and/or registers for executing the specialized computer software instructions.

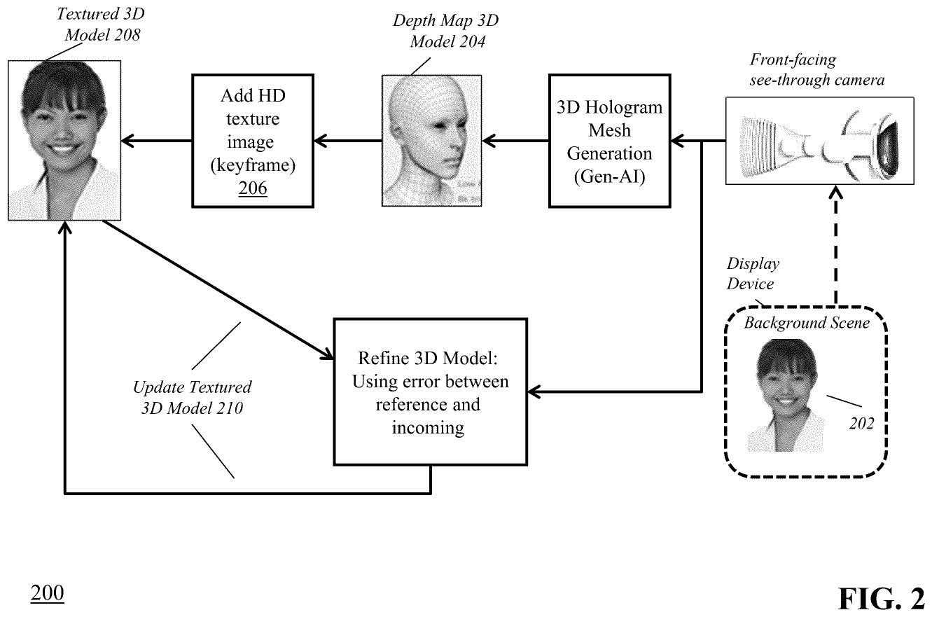

FIG. 2 is a flow diagram of a computerized method 200 of generating a textured 3D model from 2D video, using system 100 of FIG. 1. In some embodiments, a user is wearing headset device 110 while also viewing video content on display screen 108 of client computing device 106. For example, the video content can be a live sporting event or concert that depicts one or more subjects (e.g., athletes, band members), objects, and/or scenes. The user can initiate real-time conversion of 2D video being displayed on screen 108 of client device 106 into 3D holographic video content by, e.g., identifying and selecting a subject in the video content (step 202). For example, the user can select a subject using one or more functions of headset device 110, such as eye tracking (i.e., one or more sensors 124 of headset 110 configured to track the user's eyes and gaze) and/or ‘finger clicking’ (i.e., tapping or pointing at the subject in the video content). Concurrently, 3D model generation software 128 can register the pose of the display screen 108 and continue to track the location/orientation of the display screen 108 during the conversion process. In some embodiments, 3D model generation software 128 can utilize a simultaneous localization and mapping (SLAM) algorithm to perform the registration and tracking of screen 108 of client computing device 106.

Next, 3D model generation software 128 generates (step 204) a depth map and corresponding 3D model to be used in creating the 3D holographic video for the selected subject. In some embodiments, software 128 captures one or more incoming frames of the video content and generates a depth map from the frame. As can be appreciated, there are number of different techniques that can be used by software 128 to perform the conversion to a depth map, such as monocular depth map generation. An exemplary monocular depth map technique is described in A. C. S. Kumar et al., “Monocular Depth Prediction using Generative Adversarial Networks,” 2018 IEEE/CVF Conference on Computer Vision and Pattern Recognition Workshops (CVPRW), Salt Lake City, UT, USA, 2018, pp. 413-421, which is incorporated herein by reference. Software 128 then creates a 3D model of the subject using the depth map information. In some embodiments, software 128 can utilize one or more other algorithms to perform the 3D model/scene generation from input images, such as NeRF (as described in B. Mildenhall et al., “NeRF: Representing Scenes as Neural Radiance Fields for View Synthesis,” arXiv:2003.08934v2 [cs.CV] 3 Aug. 2020, available at arxiv.org/pdf/2003.08934) or Gaussian Splatting (as described in B. Kerbl et al., “3D Gaussian Splatting for Real-Time Radiance Field Rendering,” ACM Trans. Graph., Vol. 42, No. 4, Article 1, August 2023, arXiv:2308.04079v1 [cs.GR] 8 Aug. 2023, available at arxiv.org/pdf/2308.04079.pdf), each of which is incorporated herein by reference.

3D model generation software 128 then overlays (step 206) a high-definition (HD) texture onto the 3D model created from the depth map to generate a textured 3D model. In some embodiments, a HD frame of the video content is acquired by a camera of headset device 110 when viewing the video content on client device 106. In some embodiments, headset device 110 captures a keyframe from the video content and uses the keyframe as the HD texture. It should be appreciated that, at this point, only a portion of the reference 3D model is textured, corresponding to the side of the subject that is currently visible in the video content captured from client device 106.

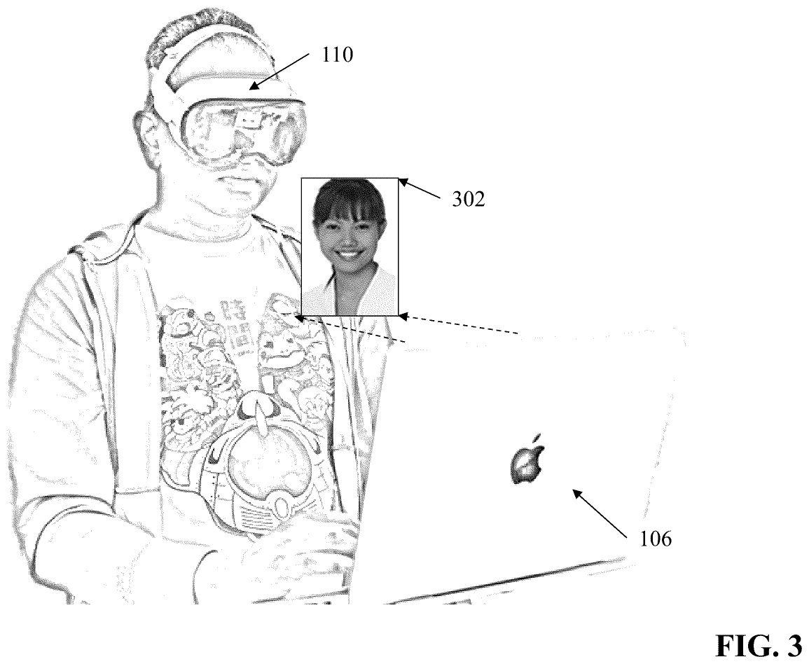

Software 128 can then reproject the textured 3D model to both the left and right stereo displays in headset device 110 to match what is currently being viewed by the user on screen 108 of client device 106. The result is a 3D holographic video stream that provides an enhanced viewing experience for the user. FIG. 3 is a diagram of an exemplary 3D holographic video stream generated by system 100. As shown in FIG. 3, the user is wearing headset 110 and viewing video content on the display screen of client computing device 106. As described above, headset 110 generates a 3D holographic video 302 of a subject from the video stream that is projected to the user on top of the video content from client computing device 106. In some embodiments, this entire process of FIG. 2 takes between one to several seconds to complete, depending upon the quality of the holographic video stream that is desired.

In some embodiments, as subsequent frames of the video content are captured by headset device 110, 3D model generation software 128 can refine (step 210) the textured 3D model using an error calculated between the current textured 3D model and the incoming frame(s). This combination of the 3D model mesh and HD keyframe image allows for future tracking of the camera and subject deformation due to motion and changes of the shape.

In some embodiments, as additional views of the subject are captured from the incoming video content, additional keyframes from different camera views of the subject are added as needed and the 3D model is filled in with additional information. In addition, incoming frames are compared with the rendered 3D model and the error between the incoming and the reference model using techniques such as feature comparisons (like optical flow (see Horn and Schunck, infra) and/or SIFT (see Lowe, infra)) can then be used to further refine and update the 3D model. In some embodiments, the refinement can also be done using generative AI processing to update the 3D model holistically. Thus, the 3D model continues to be expanded as well as refined such that the 3D reference model reflects the most accurate volumetric 3D model possible. In addition, the initial 3D model generation and texturing process typically takes between one to two seconds, and the refining step does not need to run every frame but every few seconds or so to limit resource usage.

Advantageously, user input controls available via headset device 110 can be used to manipulate the appearance of the 3D hologram (e.g., zoom in/out for improved viewing experience). If the screen 108 and/or client computing device 106 is moved, or if the user wearing headset 110 moves, software 128 tracks the screen 108/device 106 relative to headset 110 and the scene using, e.g., a spatial awareness engine and/or cameras 122 or sensors 124 on the headset. Hence, the holographic video continues to be displayed exactly at the same location in the room where the video was sourced.

As can be appreciated, to further improve the above processing of FIG. 2, system 100 can be configured to start with a 3D reference model template (e.g., a full 3D model) that gets deformed based upon the participant's key features as detected by software 128. This technique allows for a very robust 3D model shape which then matches the incoming frames.

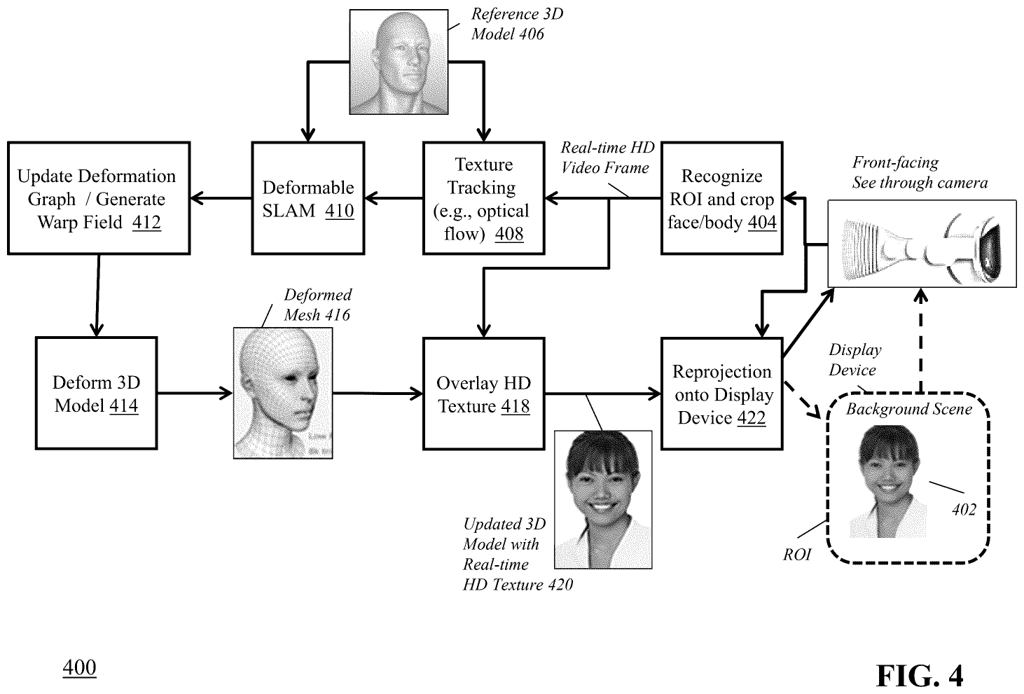

FIG. 4 is a flow diagram of a computerized method 400 of real-time conversion of 2D video into 3D holographic video content, using system 100 of FIG. 1. In some embodiments, a user is wearing headset device 110 while also viewing video content on display screen 108 of client computing device 106. For example, the video content can be a live sporting event or concert that depicts one or more subjects (e.g., athletes, band members). As described above, headset device 110 comprises cameras 122 (e.g., stereo cameras) at the front of the headset which are configured to capture and project the user's real-world surroundings onto displays 120 inside the headset 110 such that the user feels immersed in the real world. In this example, the user would see client computing device 106 as part of the projected surroundings on displays 120. In some embodiments, headset device 110 can project a virtually-rendered graphical display of video content onto displays 120 to make it appear as though the virtual graphics are part of the user's real-world surroundings. In some embodiments, headset device 110 converts the video content into a series of frames (e.g., 30-60 frames per second) and each frame of the video content is processed individually in method 400 of FIG. 4.

The user can initiate real-time conversion of 2D video being displayed on screen 108 of client device 106 into 3D holographic video content by, e.g., identifying and selecting a participant in the video content (step 402). For example, the user can select a subject using one or more functions of headset device 110. In some embodiments, headset 110 can utilize eye tracking, i.e., one or more sensors 124 of headset 110 are configured to track the user's eyes and gaze and when the user focuses on a subject, headset 110 can automatically ‘select’ the subject. In some embodiments, headset 110 can utilize one or more user input interfaces such as ‘finger clicking,’ i.e., the user taps or points at the subject in the video content, and cameras 122 and/or sensors 124 of headset 110 determine that the subject has been ‘selected.’ Concurrently, 3D model generation software 128 can register the pose of the display screen 108 and continue to track the location/orientation of the display screen 108 during the conversion process. In some embodiments, 3D model generation software 128 can utilize a simultaneous localization and mapping (SLAM) algorithm to perform the registration and tracking of screen 108 of client computing device 106.

3D model generation software 128 recognizes the region of interest (ROI) (e.g., the selected participant) in the video content and segments/crops the video content according to the ROI (step 404). In some embodiments, software 128 utilizes a facial recognition algorithm or body recognition algorithm to recognize, e.g., a texture associated with a face or body of the subject in the video content. For example, software 128 can crop the face, head/shoulders, and/or body of the participant (or, in some cases, a portion of the scene including one or more objects) depending upon what is being displayed in the video content. An exemplary segmentation model that can be used by software 128 is the Segment Anything model available from Meta, Inc. (segment-anything.com). The result of step 304 is one or more real-time HD video frames taken from the video content and cropped to include the ROI.

Concurrently, 3D model generation software 128 retrieves a reference 3D model to be used as a generic template in creating the 3D holographic video for the selected subject (step 406). As can be appreciated, 3D model generation software 128 can identify one or more characteristics of the selected subject (e.g., head visible only, body type, etc.) and retrieve a corresponding reference 3D model from a library of 3D models. In some embodiments, the reference 3D model is a closed-form model that can be morphed/adapted into a 3D hologram of the subject using the techniques described herein.

Next, 3D model generation software 128 converts the one or more real-time HD video frames into a 3D depth map and performs texture tracking (step 408). In some embodiments, software 128 can use monocular depth map generation (as described in A. C. S. Kumar, supra) to perform the conversion. For tracking, the 3D depth map of the subject from the incoming frame is compared to the reference 3D model using techniques such as landmarks (via the Scale Invariant Feature Transform (SIFT) algorithm as described in D. Lowe, “Object recognition from local scale-invariant features,” Proc. of the International Conference on Computer Vision, 1999, Vol. 2, pp. 1150-1157, which is incorporated herein by reference) or optical flow (as described in B. K. P. Horn and B. G. Schunck, “Determining Optical Flow,” Artificial Intelligence 17 (1981), pp. 185-203, which is incorporated herein by reference). This allows a way to track the movements of both the underlying mesh structure and the texture because they are related.

Software 128 computes the deformation of the 3D reference model due to movement of the subject in the video content using a deformable SLAM algorithm (step 410). Generally, deformable SLAM uses a sparse graph network to compute the deformations. As can be appreciated, an advantage of using a deformation graph is that the warp nodes within the graph are sparse and therefore computation of the deformation is very fast. An exemplary deformable SLAM algorithm is described in R. A. Newcombe et al., “DynamicFusion: Reconstruction and Tracking of Non-rigid Scenes in Real-Time,” 2015 IEEE Conference on Computer Vision and Pattern Recognition (CVPR), Boston, MA, USA, 2015, pp. 343-352, which is incorporated herein by reference. In some embodiments, software 128 can use Gaussian splat (gsplat) blendshapes to deform and track changes to the 3D reference model, as described in (i) B. Kerbl et al., “3D Gaussian Splatting for Real-Time Radiance Field Rendering,” ACM Trans. Graph., Vol. 42, No. 4, Article 1, August 2023, arXiv:2308.04079v1 [cs.GR] 8 Aug. 2023, available at arxiv.org/pdf/2308.04079.pdf; and (ii) G. Wu et al., “4D Gaussian Splatting for Real-Time Dynamic Scene Rendering,” arXiv:3210.08528v2 [cs.CV], Dec. 7, 2023, available at arxiv.org/pdf/2310.08528.pdf, which is incorporated herein by reference. An exemplary toolkit that can be used by software 128 to implement Gaussian splatting is gsplat, as described in V. Ye et al., “gsplat: An Open-Source Library for Gaussian Splatting,” arXiv:2409.06765v1 [cs.CV], Sep. 10, 2024, available at arxiv.org/pdf/2409.06765.pdf which is incorporated herein by reference.

Once software 128 computes a new deformation graph, software 128 can then generate a dense vector warp field that represents the warping of the incoming frame to the reference frame (step 412). The dense vector warp field is used to deform the reference 3D model to match the 3D model as observed in the incoming frame using the 3D depth map (step 414). The result of step 414 is a deformed mesh 416 that matches the model of the subject in the incoming frame. 3D model generation software 128 then overlays the cropped HD texture (from step 404) onto the deformed mesh to create a textured deformed 3D holographic model 420 that matches the incoming frame in real-time (step 418).

In some embodiments, software 128 can utilize a generative AI (Gen-AI) diffusion model to further improve image quality of the reprojected images from the deformed 3D model 416. Exemplary techniques for implementation of a Gen-AI diffusion model in software 128 are described in H. Cao et al., “A Survey on Generative Diffusion Models,” Journal of LaTeX Class Files, arXiV:2209.02646v10 [cs.AI], Dec. 23, 2023, available at arxiv.org/pdf/2209.02646.pdf, which is incorporated herein by reference. As can be appreciated, the improvement to image quality provided by the generative AI diffusion model increases user engagement and satisfaction with the applications described herein.

3D model generation software 128 then reprojects the 3D holographic model onto the display screen 108 of client device 106 (as viewed by the user via headset 110) and the entire image is re-rendered to now include the 3D holographic video stream (step 422). The result is a real-time 3D holographic video stream that provides a unique viewing experience, where the user sees the 3D holographic video come to life in front of them while also continuing to interact with their real-world surroundings.

Applications of the above-described methods and systems are numerous and include, but are not limited to:

Sporting Events—the technology described herein makes watching sporting events more exciting by allowing a user to follow their favorite player as a 3D hologram while still being able to watch the rest of the background and the scene. In some embodiments, the entire venue (e.g., field, stadium) and multiple players can also be transformed into live holographic video streaming.

Concerts—the technology described herein enables a user to watching the singer and/or other band members as 3D holograms to provide an incredibly immersive viewing experience.

Social Media—Any social media content on a client device can be converted into 3D holograms for unique interactions and experiences. For example, the user can interact with their favorite social media influencers who come alive as 3D holograms.

In addition to the above, the technology is applicable to any application that can benefit from more real-time immersive engagement.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the technology described herein by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™ near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A system for real-time conversion of two-dimensional (2D) video into three-dimensional (3D) holographic video content, the system comprising:
a wearable headset device including: one or more cameras configured to capture a front-facing field of view, and one or more displays configured to present digital content to a user of the headset device,
the headset device configured to:
capture, using the one or more cameras, video that includes a client computing device in proximity to the user, the client computing device comprising a screen displaying 2D video content;
for a first one or more frames of the captured video:
identify a region of interest in the first one or more frames that corresponds to a subject in the 2D video content displayed on the client computing device,
convert the first one or more frames into a first 3D depth map including creating an initial 3D model of the subject using the first depth map,
overlay an initial high-definition texture on the initial 3D model of the subject, the initial texture generated from the first one or more frames, and
reproject the textured initial 3D model in the displays of the headset device to align with the subject in the 2D video content;
for each subsequent frame of the captured video:
identify a region of interest in the subsequent frame that corresponds to the subject,
convert the subsequent frame into a subsequent 3D depth map including a current 3D model of the subject,
deform the initial 3D model of the subject to match the current 3D model of the subject,
overlay a current high-definition texture on the deformed 3D model of the subject, the current texture generated from the subsequent frame, and
reproject the textured current 3D model in the displays of the headset device to align with the subject in the 2D video content.

2. The system of claim 1, wherein the headset device registers a pose of the screen of the client computing device and tracks a location of the screen through each frame of the captured video.

3. The system of claim 2, wherein the headset device uses a simultaneous localization and mapping (SLAM) algorithm to perform the pose registration and screen tracking.

4. The system of claim 1, wherein identifying a region of interest in the first one or more frames comprises:
capturing input from the user; and
identifying the region of interest in the first one or more frames based upon the user input.

5. The system of claim 4, wherein capturing input from the user comprises determining, using one or more sensors of the headset device, a gaze of the user's eyes toward the screen of the client computing device.

6. The system of claim 4, wherein capturing input from the user comprises determining a location of the user's hand in the first one or more frames in relation to the screen of the client computing device.

7. The system of claim 1, wherein the headset device converts the frames into the 3D depth maps using a monocular depth map generation technique.

8. The system of claim 1, wherein, for each subsequent frame of the captured video, the headset device compares the current 3D model to the initial 3D model to enable tracking of the movements of both the underlying mesh structure of the 3D model and the texture.

9. The system of claim 8, wherein the headset device compares the current 3D model to the initial 3D model using landmarks or an optical flow algorithm.

10. The system of claim 1, wherein for the first one or more frames of the captured video, the headset device:
retrieves a reference 3D model based upon one or more characteristics of the subject in the 2D video content;
deforms the reference 3D model to match the initial 3D model of the subject; and
overlays the initial high-definition texture on the deformed initial 3D model of the subject to generate the textured initial 3D model.

11. The system of claim 1, wherein the headset device deforms the initial 3D model of the subject to match the current 3D model of the subject using a deformable simultaneous localization and mapping (SLAM) algorithm.

12. The system of claim 11, wherein the headset device uses a sparse deformation graph to compute the deformations and generates a dense vector warp field that represents the warping of the current frame to the previous frame.

13. The system of claim 1, wherein, for each frame of the captured video, the headset device segments the frame based upon the identified region of interest.

14. The system of claim 14, wherein the headset device uses a facial recognition algorithm or a body recognition algorithm to perform the segmentation.

15. The system of claim 1, wherein the subject in the 2D video content comprises a person and the region of interest comprises one or more of: the person's body, the person's head and shoulders, or the person's face.

16. The system of claim 1, wherein reprojecting the textured 3D model in the displays of the headset device to align with the subject in the 2D video content provides an appearance to the user that the textured 3D model is coming out of the screen of the client computing device.

17. The system of claim 16, wherein the user views the reprojected textured 3D model in context with the 2D video content.

18. The system of claim 16, wherein the user views real-world surroundings concurrently with the textured 3D model and the 2D video content.

19. The system of claim 1, wherein the headset device continually refines the textured 3D model for display to the user as each subsequent frame is processed.

20. The system of claim 1, wherein the headset device processes one or more of the initial high-definition texture and the current high-definition texture using a generative AI diffusion model algorithm to increase an image quality of the textured 3D model.

21. A computerized method of real-time conversion of two-dimensional (2D) video into three-dimensional (3D) holographic video content, the method comprising:
capturing, using one or more cameras of a wearable headset device, video that includes a client computing device in proximity to a user of the headset device, the client computing device comprising a screen displaying 2D video content;
for a first one or more frames of the captured video:
identifying, by the headset device, a region of interest in the first one or more frames that corresponds to a subject in the 2D video content displayed on the client computing device,
converting, by the headset device, the first one or more frames into a first 3D depth map including creating an initial 3D model of the subject using the depth map,
overlaying, by the headset device, an initial high-definition texture on the initial 3D model of the subject, the initial texture generated from the first frame, and
reprojecting, by the headset device, the textured initial 3D model in one or more displays of the headset device to align with the subject in the 2D video content;
for each subsequent frame of the captured video:
identifying, by the headset device, a region of interest in the frame that corresponds to the subject,
converting, by the headset device, the frame into a subsequent 3D depth map including creating a current 3D model of the subject using the subsequent depth map,
deforming, by the headset device, the initial 3D model of the subject to match the current 3D model of the subject,
overlaying, by the headset device, a current high-definition texture on the deformed 3D model of the subject, the current texture generated from the frame, and
reprojecting, by the headset device, the textured current 3D model in the displays of the headset device to align with the subject in the 2D video content.

22. The method of claim 21, wherein the headset device registers a pose of the screen of the client computing device and tracks a location of the screen through each frame of the captured video.

23. The method of claim 21, wherein the headset device uses a simultaneous localization and mapping (SLAM) algorithm to perform the pose registration and screen tracking.

24. The method of claim 21, wherein identifying a region of interest in the first one or more frames comprises:
capturing input from the user; and
identifying the region of interest in the first one or more frames based upon the user input.

25. The method of claim 24, wherein capturing input from the user comprises determining, using one or more sensors of the headset device, a gaze of the user's eyes toward the screen of the client computing device.

26. The method of claim 24, wherein capturing input from the user comprises determining a location of the user's hand in the first one or more frames in relation to the screen of the client computing device.

27. The method of claim 21, wherein the headset device converts the frames into the 3D depth maps using a monocular depth map generation technique.

28. The method of claim 21, wherein, for each subsequent frame of the captured video, the headset device compares the current 3D model to the initial 3D model to enable tracking of the movements of both the underlying mesh structure of the 3D model and the texture.

29. The method of claim 28, wherein the headset device compares the current 3D model to the initial 3D model using landmarks or an optical flow algorithm.

30. The method of claim 21, wherein for the first one or more frames of the captured video, the headset device:
retrieves a reference 3D model based upon one or more characteristics of the subject in the 2D video content;
deforms the reference 3D model to match the initial 3D model of the subject; and
overlays the initial high-definition texture on the deformed initial 3D model of the subject to generate the textured initial 3D model.

31. The method of claim 21, wherein the headset device deforms the initial 3D model of the subject to match the current 3D model of the subject using a deformable simultaneous localization and mapping (SLAM) algorithm.

32. The method of claim 31, wherein the headset device uses a sparse deformation graph to compute the deformations and generates a dense vector warp field that represents the warping of the current frame to the previous frame.

33. The method of claim 21, wherein, for each frame of the captured video, the headset device segments the frame based upon the identified region of interest.

34. The method of claim 33, wherein the headset device uses a facial recognition algorithm or a body recognition algorithm to perform the segmentation.

35. The method of claim 21, wherein the subject in the 2D video content comprises a person and the region of interest comprises one or more of: the person's body, the person's head and shoulders, or the person's face.

36. The method of claim 21, wherein reprojecting the textured 3D model in the displays of the headset device to align with the subject in the 2D video content provides an appearance to the user that the textured 3D model is coming out of the screen of the client computing device.

37. The method of claim 36, wherein the user views the reprojected textured 3D model in context with the 2D video content.

38. The method of claim 36, wherein the user views real-world surroundings concurrently with the textured 3D model and the 2D video content.

39. The method of claim 21, wherein the headset device continually refines the textured 3D model for display to the user as each subsequent frame is processed.

40. The method of claim 21, further comprising processing, by the headset device, one or more of the initial high-definition texture and the current high-definition texture using a generative AI diffusion model algorithm to increase an image quality of the textured 3D model.

41. A system for real-time conversion of two-dimensional (2D) video into three-dimensional (3D) holographic video content, the system comprising:
a wearable headset device including: one or more cameras configured to capture a front-facing field of view, and one or more displays configured to present digital content to a user of the headset device,
the headset device configured to:
capture, using the one or more cameras, video that includes a client computing device in proximity to the user, the client computing device comprising a screen displaying 2D video content;
for a first one or more frames of the captured video:
identify a region of interest in the first one or more frames that corresponds to a subject in the 2D video content displayed on the client computing device,
convert the first one or more frames into a first 3D depth map including creating an initial 3D model of the subject using the first depth map,
retrieve a reference 3D model based upon one or more characteristics of the subject in the 2D video content;
deform the reference 3D model to match the initial 3D model of the subject; and
overlay an initial high-definition texture on the deformed initial 3D model of the subject to generate the textured initial 3D model, the initial texture generated from the first one or more frames, and
reproject the textured initial 3D model in the displays of the headset device to align with the subject in the 2D video content;
for each subsequent frame of the captured video:
identify a region of interest in the subsequent frame that corresponds to the subject,
convert the subsequent frame into a subsequent 3D depth map including creating a current 3D model of the subject using the subsequent depth map,
deform the initial 3D model of the subject to match the current 3D model of the subject,
overlay a current high-definition texture on the deformed 3D model of the subject, the current texture generated from the subsequent frame, and
reproject the textured current 3D model in the displays of the headset device to align with the subject in the 2D video content.

42. A computerized method of real-time conversion of two-dimensional (2D) video into three-dimensional (3D) holographic video content, the method comprising:
capturing, using one or more cameras of a wearable headset device, video that includes a client computing device in proximity to a user of the headset device, the client computing device comprising a screen displaying 2D video content;
for a first one or more frames of the captured video:
identifying, by the headset device, a region of interest in the first one or more frames that corresponds to a subject in the 2D video content displayed on the client computing device,
converting, by the headset device, the first one or more frames into a first 3D depth map including creating an initial 3D model of the subject using the depth map,
retrieving, by the headset device, a reference 3D model based upon one or more characteristics of the subject in the 2D video content;
deforming, by the headset device, the reference 3D model to match the initial 3D model of the subject;
overlaying, by the headset device, an initial high-definition texture on the initial 3D model of the subject, the initial texture generated from the first frame, and
reprojecting, by the headset device, the textured initial 3D model in one or more displays of the headset device to align with the subject in the 2D video content;
for each subsequent frame of the captured video:
identifying, by the headset device, a region of interest in the frame that corresponds to the subject,
converting, by the headset device, the frame into a subsequent 3D depth map including creating a current 3D model of the subject using the subsequent depth map,
deforming, by the headset device, the initial 3D model of the subject to match the current 3D model of the subject,
overlaying, by the headset device, a current high-definition texture on the deformed 3D model of the subject, the current texture generated from the frame, and
reprojecting, by the headset device, the textured current 3D model in the displays of the headset device to align with the subject in the 2D video content.
